(19) United States
(12) Patent Application Publication
(10) Pub. No.: US 2012/0111704 A1
(43) Pub. Date: May 10, 2012

(54) Apparatus and Method for a User Input Element in an Electronic Device

(75) Inventors: Josef Stöhr, Langenau (DE); Martin Punke, Mittelbiberach (DE)

(73) Assignee: NOKIA CORPORATION, Espoo (FI)

(21) Appl. No.: 12/940,175

(22) Filed: Nov. 5, 2010

(51) Int. Cl. H01H 13/14

(52) U.S. Cl. 200/341

(57) ABSTRACT

In accordance with an example embodiment of the present invention, an apparatus is disclosed, comprising: a translucent user input element body; a first layer comprising a first shade, the first layer disposed on a surface of the translucent user input element body; a second layer comprising a second shade, the second layer disposed on a surface of the first layer; an aperture through the first layer and the second layer, the aperture having a character shape; and the first layer comprising an exposed portion configured to form a dark outline for the character shape.

### TECHNICAL FIELD

The present application relates generally to an apparatus and method for a user input element in an electronic device.

### BACKGROUND

Electronic devices are typically provided with user input elements that enable users to interact with a device. User input elements may serve a large variety of purposes, including input of data, selection of items and functions, indicating directions, toggling between states, and starting or stopping operations. User input elements can have many different shapes, materials, color shades, and layouts, and they are often provided with symbols that enable the user to recognize the purpose assigned to a user input element. It is often desirable to provide user input elements with illumination for facilitating their use in low lighting conditions, or drawing the user's attention into an illuminated user input element.

Electronic devices feature various keypad arrangements, such as ITU-T keypads, QWERTY keypads, directional keys, and other types of keys and buttons. Keys and keypads are commonly provided with backlighting, which is a form of illumination in which light emanating from the inside of the device is directed through an at least partially transparent or translucent user input element body. User input element arrangements in mobile electronic devices must satisfy requirements such as ease of use, clarity of symbols and markings over a broad range of lighting conditions and use situations, and suitability to mass manufacturing. Aesthetic appeal is also a factor that influences choices of consumers, and consequently drives development of mobile devices. Mobile electronic devices, such as mobile phones, portable computers, gaming devices, and other portable devices, are often produced in different color varieties in order to match the preferences of different markets and individuals. For example, devices with white, silver, or other light colored keypads are preferred by many users.

### SUMMARY

Various aspects of examples of the invention are set out in the claims.

According to a first aspect of the present invention, an apparatus is disclosed, comprising: a translucent user input element body; a first layer comprising a first shade, the first layer disposed on a surface of the translucent user input element body; a second layer comprising a second shade, the second layer disposed on a surface of the first layer; an aperture through the first layer and the second layer, the aperture having a character shape; and the first layer comprising an exposed portion configured to form a dark outline for the character shape.

According to a second aspect of the present invention, an apparatus is disclosed, comprising: a user input element, the user input element comprising: a translucent user input element body; a first layer comprising a first shade, the first layer disposed on a surface of the translucent user input element body; a second layer comprising a second shade, the second layer disposed on a surface of the first layer; an aperture through the first layer and the second layer, the aperture having a character shape; and the first layer comprising an exposed portion configured to form a dark outline for the character shape; a backlight arrangement configured to direct light through the user input element.

According to a third aspect of the present invention, a method is disclosed, comprising: providing a translucent user input element body; providing a first layer having a first shade, the first layer disposed on a surface the translucent user input element body; providing a second layer having a second shade, the second layer disposed on a surface of the first layer; forming an aperture in the first layer and the second layer, the aperture having a character shape; and configuring the first layer to comprise an exposed portion to form a dark outline for the character shape.

### BRIEF DESCRIPTION OF THE DRAWINGS

For a more complete understanding of example embodiments of the present invention, reference is now made to the following descriptions taken in connection with the accompanying drawings in which:

FIG. 1a is a diagram illustrating a cross-sectional view of a user input element comprising an aperture on its top surface, the aperture comprising an angle, according to an example embodiment of the invention;

FIG. 1b is a diagram illustrating a cross-sectional view of a user input element comprising an aperture on its top surface, the aperture comprising an offset, according to an example embodiment of the invention;

FIG. 1c is a diagram illustrating a top view of the user input element comprising a character shaped aperture on its top surface, according to an example embodiment of the invention;

FIG. 2a is a diagram illustrating a cross-sectional view of a user input element comprising an aperture on its back surface, the aperture comprising an angle, according to an example embodiment of the invention;

FIG. 2b is a diagram illustrating a cross-sectional view of a user input element comprising an aperture on its back surface, the aperture comprising an offset, according to an example embodiment of the invention;

FIG. 2c is a diagram illustrating a top view of the user input element comprising a character shaped aperture on its back surface, according to an example embodiment of the invention;

FIG. 3 is a block diagram illustrating a device comprising a user input element and a backlight arrangement, according to an example embodiment of the invention;

FIG. 4 is a diagram illustrating a mobile electronic device comprising an ITU-T keypad, according to an example embodiment of the invention;

FIG. 5 is a diagram illustrating a mobile electronic device comprising a QWERTY keypad, according to an example embodiment of the invention;

FIG. 6 is a flow diagram illustrating a method of manufacturing a user input element with a character shaped aperture, the method comprising laser engraving, according to an example embodiment of the invention;

FIG. 7 is a flow diagram illustrating a method of manufacturing a user input element with a character shaped aperture, the method comprising forming an offset, according to an example embodiment of the invention;

FIG. 8a is a diagram illustrating a cross-sectional view of a user input element comprising an aperture, the aperture being formed by printing a first layer and a second layer, according to an example embodiment of the invention;

FIG. 8b is a diagram illustrating a cross-sectional view of a user input element comprising an aperture, the aperture being formed by printing and laser treatment, according to an example embodiment of the invention;

FIG. 8c is a diagram illustrating a cross-sectional view of a user input element comprising an aperture, the aperture being formed by printing a first layer and a second layer overlaying the first layer, according to an example embodiment of the invention; and

FIG. 8d is a diagram illustrating a cross-sectional view of a user input element comprising an aperture, the aperture being formed by printing and laser etching, according to an example embodiment of the invention.

### DETAILED DESCRIPTION OF THE DRAWINGS

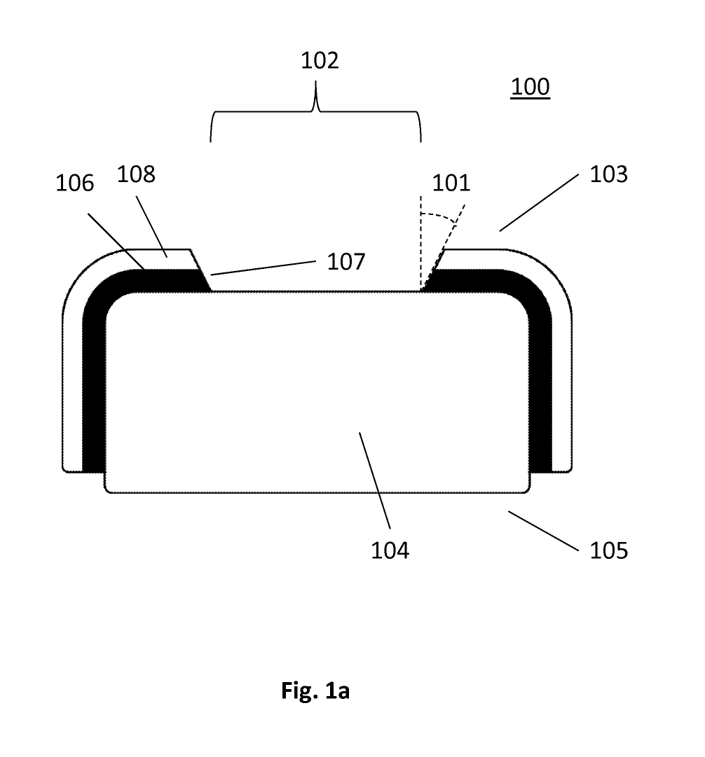

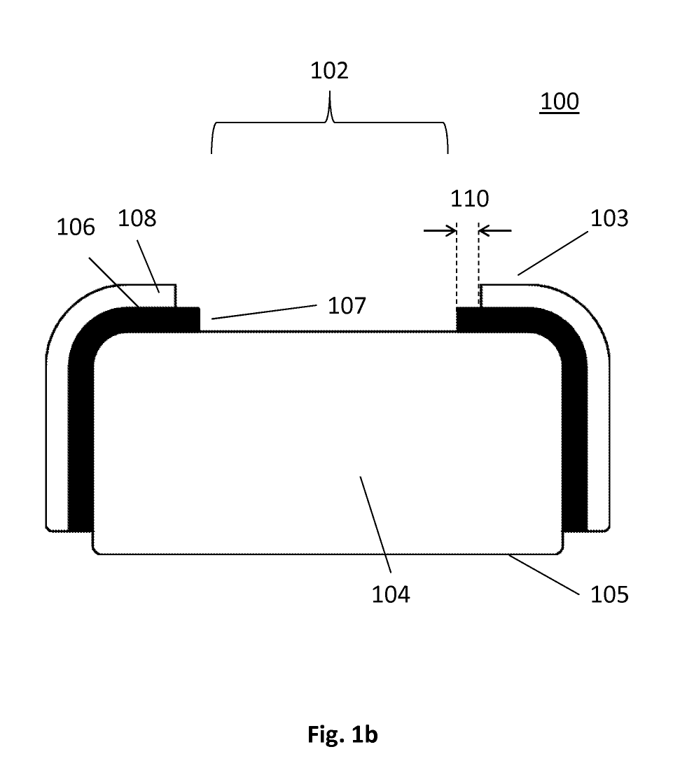

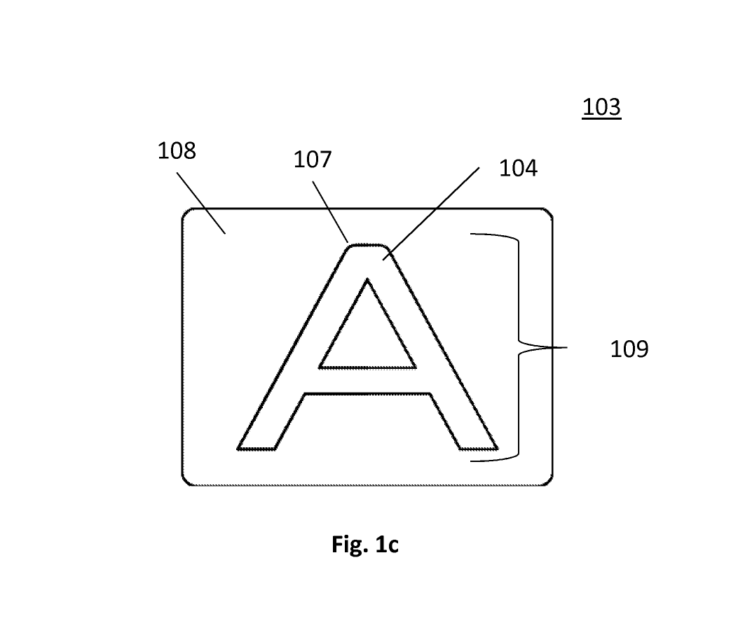

An example embodiment of the present invention and its potential advantages are understood by referring to FIGS. 1 through 8 of the drawings.

FIG. 1a is a diagram illustrating a cross-sectional view of a user input element 100 comprising an aperture 102 on its top surface 103, the aperture 102 comprising an angle 101, according to an example embodiment of the invention. The top surface 103 is a surface which is configured to be exposed and accessible to a user and to receive a force exerted by a finger or other object. The user input element further comprises a back surface 105, which is a surface generally opposite and facing away from the top surface 103. In an embodiment, the user input element 100 comprises a user input element body 104, a first layer 106 overlaying a portion of the user input element body 104, and a second layer 108 overlaying a portion of the first layer 106.

In an embodiment, the user input element body 104 comprises a translucent material, configured to allow at least partial transmission of light through the user input element body 104. The translucent material may be translucent for visible light, and it may be translucent for other parts of the electromagnetic radiation spectrum, such as infrared or ultraviolet light. In an embodiment, the translucent material comprises polycarbonate, but any suitable material may be used without departing from the spirit of the invention. The user input element body 104 may be injection molded as one piece, but other structures and manufacturing methods are possible without departing from the spirit of the invention.

In an embodiment, the first layer 106 is overlaying a portion of the top surface 103 of the user input element 100. The second layer 108 may be overlaying a portion of the first layer 106. The first layer 106 and the second layer 108 may extend to one or more other surfaces than the top surface 103. In an embodiment, the first layer 106 and the second layer 108 comprise contrasting shades. In an embodiment, the first layer 106 comprises a dark shade, and the second layer 108 comprises a light shade. The dark shade may be black, but a dark shade of any color may be used without departing from the spirit of the invention. The light shade may be white or silver, but a light shade of any color may be used without departing from the spirit of the invention.

In an embodiment, the aperture 102 is formed in such a way that it extends through the second layer 108 and the first layer 106. The user input element 100 comprising aspects of the invention may therefore be configured to allow rays of light directed through the user input element body 104 to emanate from the aperture 102. In an embodiment, the aperture 102 is formed in such a way that the first layer 106 comprises an exposed layer portion 107. The angle 101 is the angle between an edge of the aperture 102 and a surface normal of the top surface 103. The angle 101 can be any suitable angle.

FIG. 1b is a diagram illustrating a cross-sectional view of a user input element 100 comprising an aperture 102 on its top surface 103, the aperture 102 comprising an offset 110, according to an example embodiment of the invention. The user input element of FIG. 1b comprises a user input element body 104, a top surface 103, a back surface 105, a first layer 106, and a second layer 108 similarly as in FIG. 1a.

In an embodiment, the aperture 102 is formed in such a way that it extends through the second layer 108 and the first layer 106. The user input element 100 comprising aspects of the invention may therefore be configured to allow rays of light directed through the user input element body 104 to emanate from the aperture 102. In an embodiment, the aperture 102 is formed in such a way that the first layer 106 comprises an exposed layer portion 107. In an embodiment, an edge of the aperture 102 in the first layer 106 comprises an offset 110 in relation to an edge of the aperture 102 in the second layer 108 in such a way that a portion of the second layer 108 forms the exposed layer portion 107.

FIG. 1c is a diagram illustrating a top view of a user input element comprising a character shaped aperture 109 on its top surface 103, according to an example embodiment of the invention. The aperture having the character shaped aperture 109 may be the aperture 102 of FIG. 1a or 1b. The user input element may be the user input element 100 of FIG. 1a or 1b, or a combination having both angles 101 as in FIG. 1a and offsets 110 as in FIG. 1b. FIG. 1c illustrates the top surface 103 from the viewpoint of a user, from a direction approximately perpendicular to the top surface 103. The character shaped aperture 109 shown in FIG. 1c is a capital letter “A” of the Latin alphabet. However, the character shaped aperture 109 may be any letter of any alphabet writing system, any numeral character of any numeral system, a punctuation mark, a special character, or any other symbol or shape. In an embodiment, an exposed layer portion 107 forms a dark outline for the character shaped aperture 109, the dark outline contrasting with the user input element body 104 and the second layer 108. The exposed layer portion 107 may be the exposed layer portion 107 of FIG. 1a or 1b.

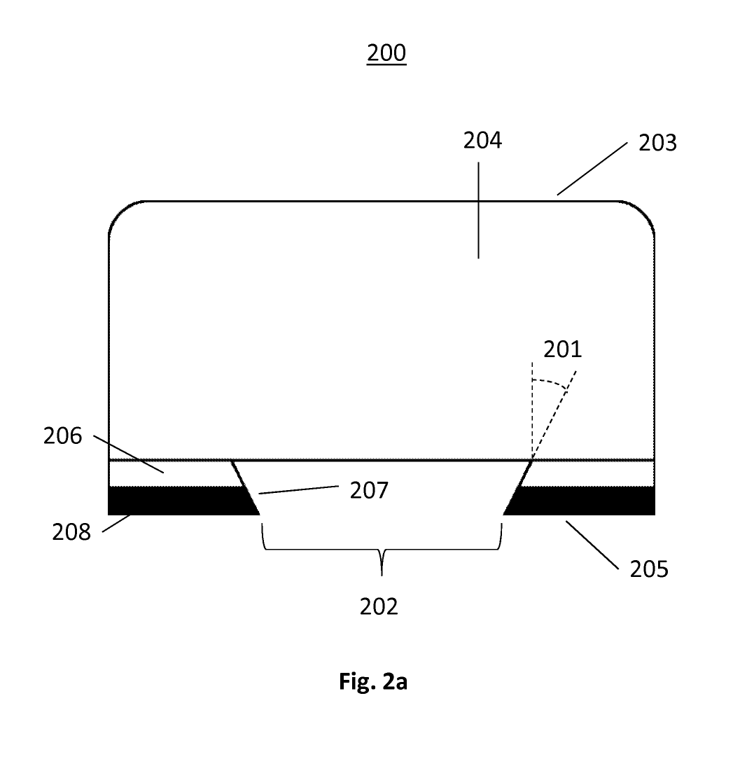

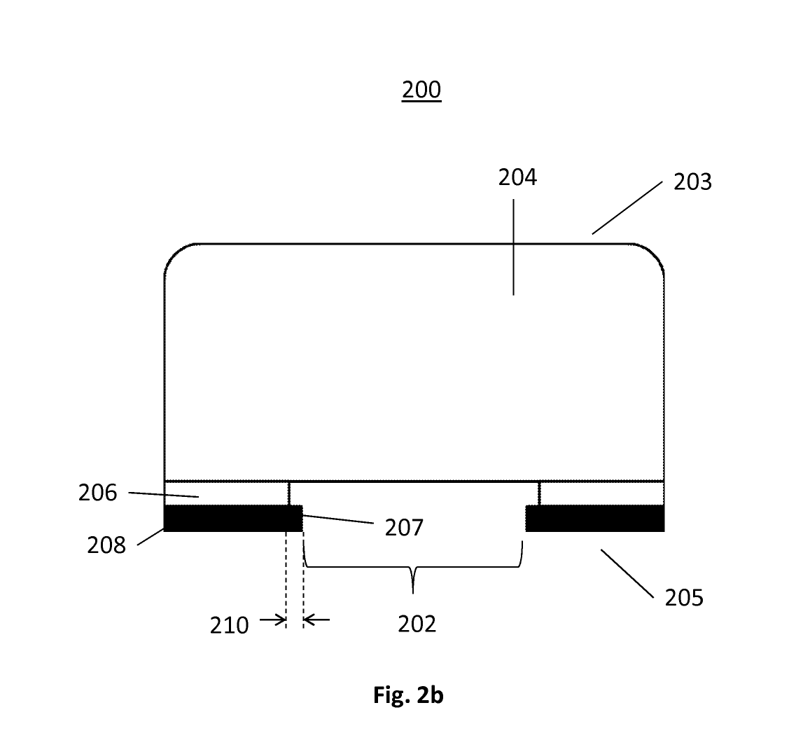

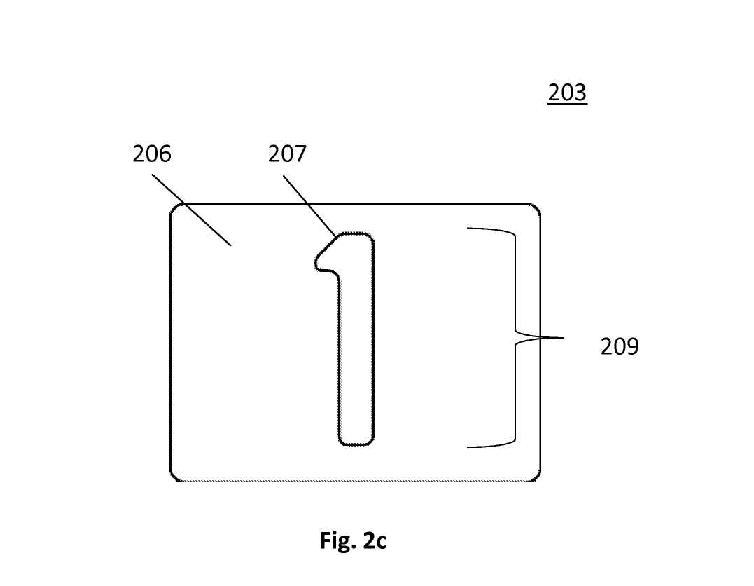

FIG. 2a is a diagram illustrating a cross-sectional view of a user input element 200 comprising an aperture 202 on it back surface 205, the aperture 202 comprising an angle 201, according to an example embodiment of the invention. The back surface 205 is a surface generally opposite to and facing away from a top surface 203, the top surface 203 being a surface which is configured to be exposed and accessible to a user and to receive a force exerted by a finger or other object. In an embodiment, the user input element 200 comprises a user input element body 204, a first layer 206 overlaying a portion of the user input element body 204, and a second layer 208 overlaying a portion of the first layer 206.

In an embodiment, the user input element body 204 comprises a translucent material, allowing at least partial transmission of light through the user input element body 204. The translucent material may be translucent for visible light, and it may be translucent for other parts of the electromagnetic radiation spectrum, such as infrared or ultraviolet light. In an embodiment, the translucent material comprises polycarbonate, but any suitable material may be used without departing from the spirit of the invention. The user input element body 204 may be injection molded as one piece, but other structures and manufacturing methods are possible without departing from the spirit of the invention.

In an embodiment, the first layer 206 is overlaying a portion of the back surface of the user input element body 204. The second layer 208 may be overlaying a portion of the first layer 206. The first layer 206 and the second layer 208 may extend to one or more surfaces other than the top surface 203 of the user input element 200. In an embodiment, the first layer 206 and the second layer 208 comprise contrasting shades. In an embodiment, the first layer 206 comprises a light shade, and the second layer 208 comprises a dark shade. The light shade may be white or silver, but a light shade of any color may be used without departing from the spirit of the invention. The dark shade may be black, but a dark shade of any color may be used without departing from the spirit of the invention.

In an embodiment, the aperture 202 is formed in such a way that it extends through the second layer 208 and the first layer 206. The user input element 200 comprising aspects of the invention may therefore be configured to allow rays of light directed through the aperture 202 to emanate through the user input element body 204. In an embodiment, the aperture 202 is formed in such a way that the second layer 208 comprises an exposed layer portion 207. The angle 201 is the angle between an edge of the aperture 202 and a surface normal of the back surface 205. The angle 201 can be any suitable angle.

FIG. 2b is a diagram illustrating a cross-sectional view of a user input element 200 comprising an aperture 202 on its back surface 205, the aperture 202 comprising an offset 210, according to an example embodiment of the invention. The user input element of FIG. 2b comprises a user input element body 204, a top surface 203, a back surface 205, a first layer 206, and a second layer 208 similarly as in FIG. 2a.

In an embodiment, the aperture 202 is formed in such a way that it extends through the second layer 208 and the first layer 206. The user input element 200 comprising aspects of the invention may therefore be configured to allow rays of light directed through the user input element body 204 to emanate from the aperture 202. In an embodiment, the aperture 202 is formed in such a way that the first layer 206 comprises an exposed layer portion 207. In an embodiment, an edge of the aperture 202 in the second layer 208 comprises an offset 210 in relation to an edge of the aperture 202 in the first layer 206 in such a way that a portion of the second layer forms 208 the exposed layer portion 207.

FIG. 2c is a diagram illustrating a top view of a user input element comprising a character shaped aperture 209 on its back surface, according to an example embodiment of the invention. The character shaped aperture 209 may be the aperture 202 of FIG. 2a or 2b. The user input element may be the user input element 200 of FIG. 2a or 2b, or a combination having both angles 201 as in FIG. 2a and offsets 210 as in FIG. 2b. FIG. 2c illustrates the user input element from the viewpoint of a user, from a direction approximately perpendicular to a top surface, which may be the top surface 203 of FIG. 2a or 2b. The character shaped aperture 209 shown in FIG. 2c is a number character “1” of the Arabic numerals. However, the character shaped aperture 209 may be any letter of any alphabet writing system, any numeral character of any numeral system, a punctuation mark, a special character, or any other symbol or shape. In an embodiment, an exposed layer portion 207 forms a dark outline for the character shaped aperture 209, the dark outline contrasting with the user input element body 204 of FIG. 2a or 2b and the first layer 206. The exposed layer portion 207 may be a portion of the second layer 208 of FIG. 2a or 2b. In an embodiment, the character shaped aperture 209, the first layer 206, and the exposed layer portion 207 are visible for a user through the user input element body 204.

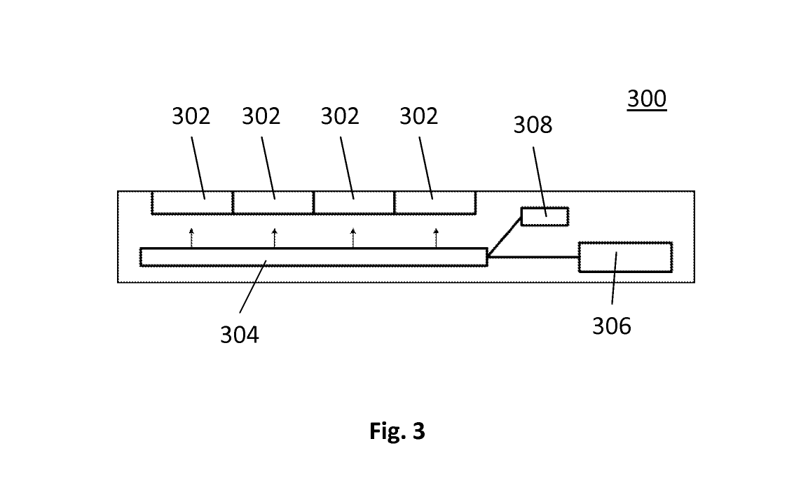

FIG. 3 is a block diagram illustrating a device 300 comprising a user input element 302 and a backlight arrangement 304, according to an example embodiment of the invention. By way of example, the device 300 may be a mobile telephone, a portable computer, an audio player, a multimedia device, a gaming device, a navigation device, an electronic book reader, and/or another type of electronic device. The device 300 comprises at least one user input element 302 according to an embodiment of the invention. In an embodiment, the device 300 comprises a plurality of user input elements, which may be of different types and shapes, and having different functionalities assigned to them. In an embodiment, the device 300 comprises a backlight arrangement 304 configured to illuminate one or more of the user input elements 302. The backlight arrangement 304 is positioned in such a way in relation to the user input elements 302 that at least part of the rays of light emanating from the backlight arrangement 304 are directed to the user input elements 302. Paths of rays of light are indicated with arrows in FIG. 3. In an embodiment, the backlight arrangement comprises one or more light emitting diode (LED), organic light emitting diode (OLED), or electroluminescent (EL) light sources and a light guide arrangement. However, any type or lighting arrangement may be used without departing from the spirit of the invention. In an embodiment, the light sources are configured to emit white light. However, any color or a combination of colors can be used without departing from the spirit of the invention. The device 300 comprises a power source 306, such as a battery, for providing electric power for the backlight arrangement, and a processor 308 for controlling the backlight arrangement. The device 300 may also comprise a display, a microphone, a loudspeaker, an antenna, and other elements not shown in FIG. 3.

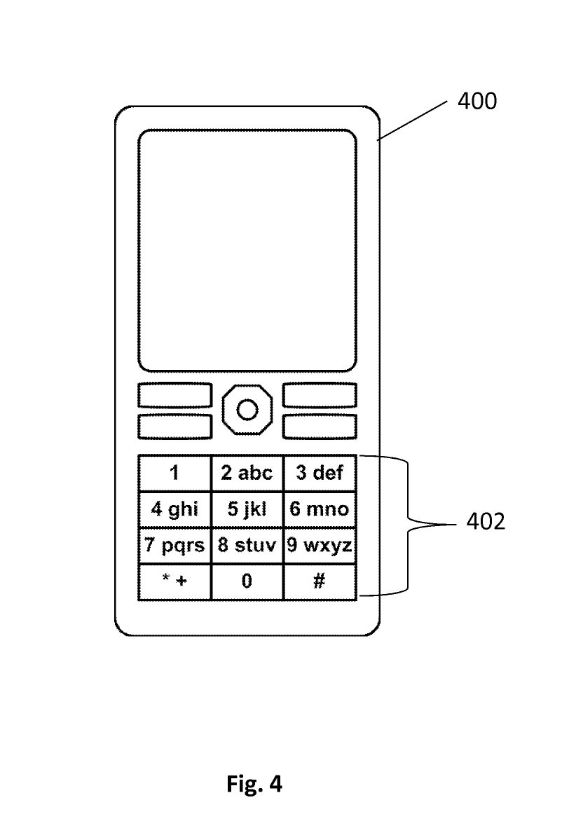

FIG. 4 is a diagram illustrating a mobile electronic device 400 comprising an ITU-T keypad 402, according to an example embodiment of the invention. The mobile electronic device 400 may be a mobile telephone. In an embodiment, the mobile electronic device 400 comprises other user input elements in addition to the ITU-T keypad 402. Embodiments of the invention may be comprised in some or all of the user input elements in the mobile electronic device 400.

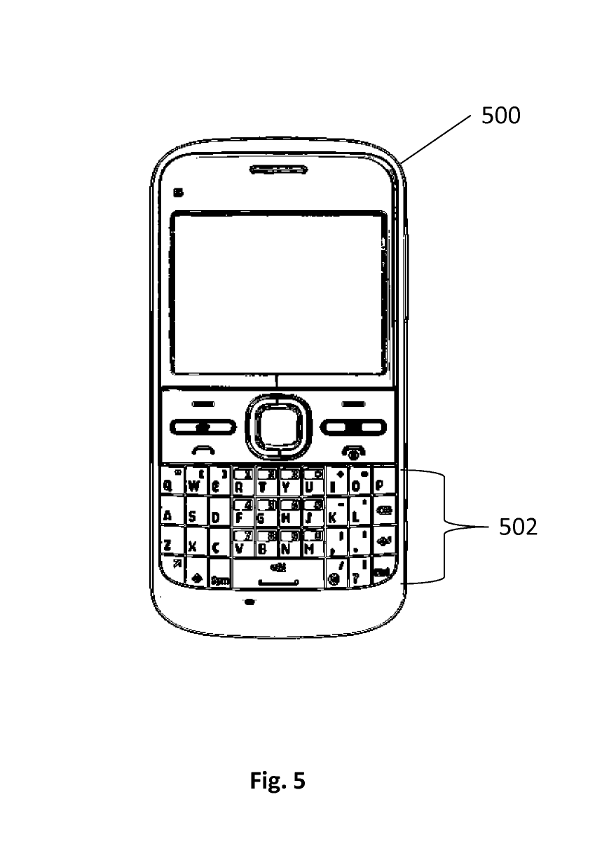

FIG. 5 is a diagram illustrating a mobile electronic device 500 comprising a QWERTY keypad 502, according to an example embodiment of the invention. The mobile electronic device 500 may be a mobile telephone. In an embodiment, the mobile electronic device 500 comprises other user input elements in addition to the QWERTY keypad 502. Embodiments of the invention may be comprised in some or all of the user input elements in the mobile electronic device 500.

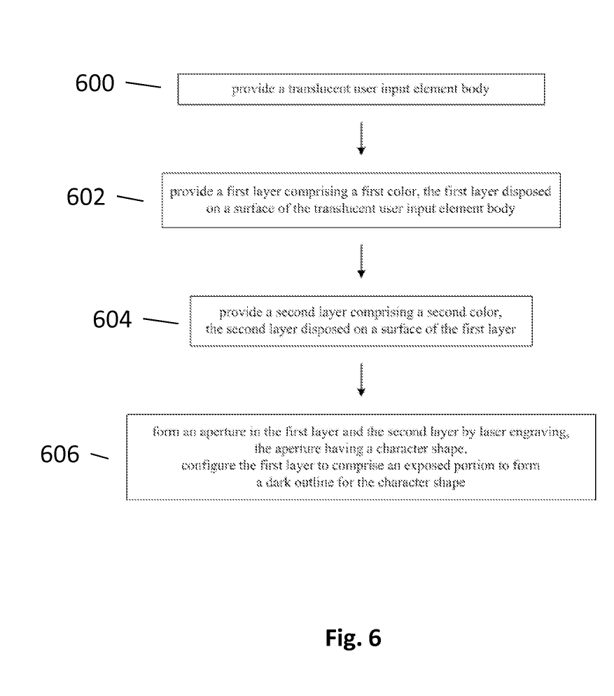

FIG. 6 is a flow diagram illustrating a method of manufacturing a user input element 100 of FIG. 1c with a character shaped aperture 109 of FIG. 1c, or a user input element 200 of FIG. 2c with a character shaped aperture 209 of FIG. 2c, the method comprising laser engraving, according to an example embodiment of the invention. At 600, a user input element body 104 of FIGS. 1a and 1c, or a user input element body 204 of FIGS. 2a and 2c is provided. In an embodiment, the user input element body 104 or 204 comprises a translucent material, configured to allow at least partial transmission of light through the user input element body 104 or 204. The translucent material may be translucent for visible light, and it may be translucent for other parts of the electromagnetic radiation spectrum, such as infrared or ultraviolet light. In an embodiment, the translucent material comprises polycarbonate, but any suitable material may be used without departing from the spirit of the invention. The user input element body 104 or 204 may be injection molded as one piece, but other structures and manufacturing methods are possible without departing from the spirit of the invention.

At 602, the first layer 106 of FIGS. 1a and 1c or the first layer 206 of FIGS. 2a and 2c is provided, the first layer 106 or 206 comprising a first shade and overlaying the user input element body 104 or 204. The first layer 106 or 206 is disposed on a portion of a surface of the user input element body. In an embodiment, the surface is the top surface 103 of FIGS. 1a and 1c. In an embodiment, the surface is the back surface 205 of FIG. 2a. At 604, the second layer 108 of FIGS. 1a and 1c or the second layer 208 of FIG. 2a is provided, the second layer 108 or 208 overlaying a portion of the first layer 106 or 206. The first layer 106 or 206, and the second layer 108 or 208 may be provided using a printing process. However, any method of applying a layer of material can be used without departing from the spirit of the invention.

At 606, the character shaped aperture 109 of FIG. 1c, or the character shaped aperture 209 of FIG. 2c is formed through the first layer 106 and the second layer 108, or through the second layer 208 and the first layer 106. The forming of the character shaped aperture 109 or 209 may be carried out using laser engraving. However, chemical etching, chemical activation, mechanical milling, or any other method of removing a layer of material can be used without departing from the spirit of the invention. The forming of the character shaped aperture 109 or 209 is carried out in such a way that the angle 101 of FIG. 1a, or angle 201 of FIG. 2a is formed. In an embodiment, the forming of the angle 101 or 201 is carried out by adjusting the angle of the laser beam used for laser engraving. As a result of forming the character shaped aperture 109 or 209, the exposed layer portion 107 of FIGS. 1a and 1c, or the exposed layer portion 207 of FIGS. 2a and 2c is formed, and the exposed layer portion 107 or 207 is configured to form a dark outline for the character shaped aperture 109 or 209.

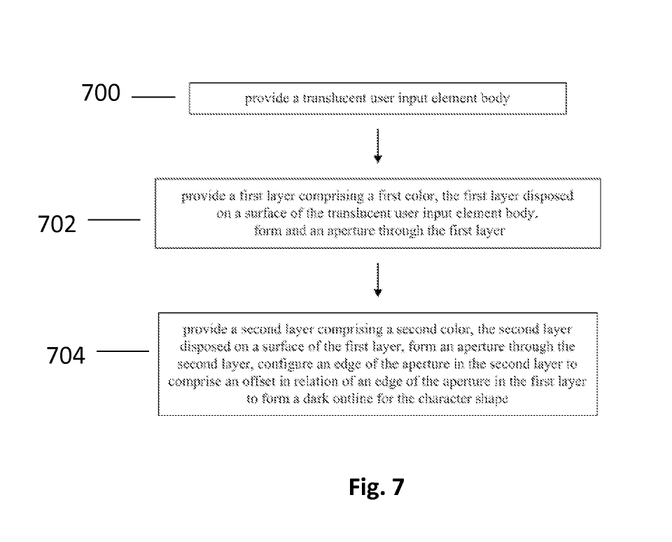

FIG. 7 is a flow diagram illustrating a method of manufacturing a user input element 100 of FIG. 1b with a character shaped aperture 109 of FIG. 1c, or a user input element 200 of FIG. 2b with a character shaped aperture 209 of FIG. 2c, the method comprising forming an offset, according to an example embodiment of the invention. At 700, a user input element body 104 of FIGS. 1b and 1c, or a user input element body 204 of FIGS. 2b and 2c is provided. In an embodiment, the user input element body 104 or 204 comprises a translucent material, configured to allow at least partial transmission of light through the user input element body 104 or 204. The translucent material may be translucent for visible light, and it may be translucent for other parts of the electromagnetic radiation spectrum, such as infrared or ultraviolet light. In an embodiment, the translucent material comprises polycarbonate, but any suitable material may be used without departing from the spirit of the invention. The user input element body 104 or 204 may be injection molded as one piece, but other structures and manufacturing methods are possible without departing from the spirit of the invention.

At 702, the first layer 106 of FIG. 1b, or the first layer 206 of FIGS. 2b and 2c is provided, the first layer 106 or 206 comprising a first shade, overlaying a portion of the user input element body 104 or 204, and comprising the character shaped aperture 109 of FIG. 1c, or 209 of FIG. 2c. The first layer 106 or 206 is disposed on a portion of a surface of the user input element body. In an embodiment, the surface is the top surface 103 of FIGS. 1b and 1c. In an embodiment, the surface is the back surface of 205 FIG. 2b. At 704, the second layer 108 of FIGS. 1b and 1c, or 208 of FIG. 2b is provided, the second layer 108 or 208 overlaying a portion of the first layer 106 or 206, and comprising the character shaped aperture 109 of FIG. 1c, or 209 of FIG. 2c. The first layer 106 or 206, and the second layer 108 or 208 may be provided using a printing process. However, any method of applying a layer of material can be used without departing from the spirit of the invention.

The first layer 106 or 206, and the second layer 108 or 208 are formed in such a way that an edge of the aperture 102 of FIG. 1b, or the aperture 202 of FIG. 2b in the second layer 108 or 208 comprises the offset 110 of FIG. 1b, or the offset 210 of FIG. 2b in relation to an edge of the aperture 102 or 202 in the first layer 106 or 206. As a result, the exposed portion 107 of FIGS. 1b and 1c, or the exposed layer portion 207 of FIGS. 2b and 2c is formed, and the exposed layer portion 107 or 207 is configured to form a dark outline for the character shaped aperture 109 or 209. In an embodiment, the offset 110 or 210 is formed during printing of the second layer 108 or 208. In an embodiment, the offset 110 or 210 is formed after printing of the second layer 108 or 208. The forming of the offset 110 or 210 after printing may be carried out by removing material by laser etching or other suitable method.

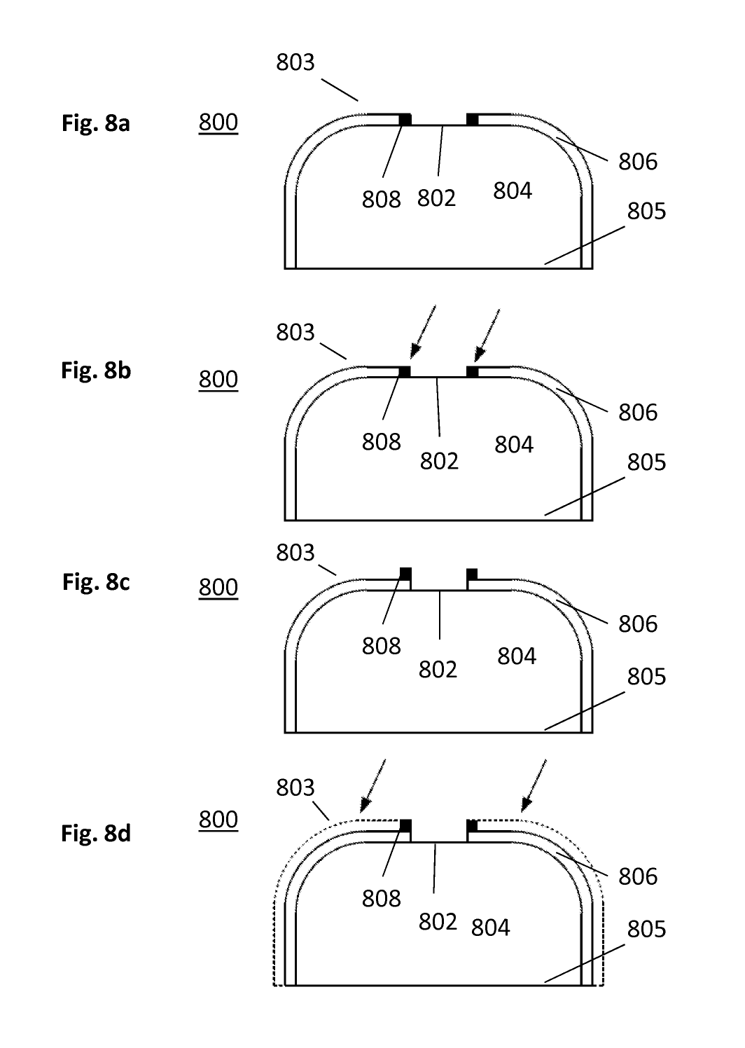

FIG. 8a is a diagram illustrating a cross-sectional view of a user input element 800 comprising an aperture 802, the aperture 802 being formed by printing a first layer 806 and a second layer 808, according to an example embodiment of the invention. In an embodiment, the first layer 806 and the second layer 808 are printed adjacent to each other on a surface of a user input element body 804. The first layer 806 and the second layer 808 may be disposed on a top surface 803 and/or a back surface 805 of the user input element body 804. The second layer 808 is configured to form a dark outline around the aperture 802.

FIG. 8b is a diagram illustrating a cross-sectional view of a user input element 800 comprising an aperture 802, the aperture being formed by printing and laser treatment, according to an example embodiment of the invention. In an embodiment, a first layer 806 is printed on a top surface 803 and/or a back surface 805 of the user input element body 804. After printing, a portion of the first layer 806 is treated with a laser beam to cause at least partial carbonization and/or chemical activation of a portion of the first layer 806, converting it to a second layer 808. The arrows in FIG. 8b illustrate the laser treatment. The second layer 808 is configured to form a dark outline around the aperture 802.

FIG. 8c is a diagram illustrating a cross-sectional view of a user input element 808 comprising an aperture 802, the aperture 802 being formed by printing a first layer 806 and a second layer 808 overlaying the first layer 806, according to an example embodiment of the invention. The first layer 806 and the second layer 808 may be printed on a top surface 803 and/or a back surface 805 of the user input element body 804. The second layer 808 is configured to form a dark outline around the aperture 802.

FIG. 8d is a diagram illustrating a cross-sectional view of a user input element 800 comprising an aperture 802, the aperture 802 being formed by printing and laser etching, according to an example embodiment of the invention. In an embodiment, a first layer 806 is printed on a top surface 803 and/or a back surface 805 of the user input element body 804, and a second layer 808 is printed on the first layer 806. After the printing of the second layer 808, a portion of the second layer is removed by laser etching. The arrows in FIG. 8d illustrate the laser etching. Other suitable methods of removing a layer of material may be used. The second layer 808 is configured to form a dark outline around the aperture 802.

A user input element according an embodiment of the invention may be a combination of elements and structures illustrated in FIGS. 1, 2, and 8. In an embodiment, a character shape is comprised both on a top surface of a user input element as in FIGS. 1a-1c and 8a-d, and on a back surface as in FIGS. 2a-2c. A method of manufacturing according to an embodiment of the invention may be a combination of the methods of manufacturing illustrated in FIGS. 6-8. In an embodiment, a character shape is formed both on a top surface of a user input element as in FIGS. 1a-1c and 8a-d, and on a back surface as in FIGS. 2a-2c.

Without in any way limiting the scope, interpretation, or application of the claims appearing below, a technical effect of one or more of the example embodiments disclosed herein is that user input element is provided, the user input element having a light shaded surface with character shapes that can be illuminated with white backlight, the character shapes being surrounded by a contrasting outline. Another technical effect of one or more of the example embodiments disclosed herein is that the character shapes can be easily distinguished from the surrounding light shaded surface, both when the backlight is on and when the backlight is off. Another technical effect of one or more of the example embodiments disclosed herein is that the keypad is suitable for mass manufacturing.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. An apparatus, comprising:
a translucent user input element body;
a first layer comprising a first shade, the first layer disposed on a surface of the translucent user input element body;
a second layer comprising a second shade, the second layer disposed on a surface of the first layer;
an aperture through the first layer and the second layer, the aperture having a character shape; and
the first layer comprising an exposed portion configured to form a dark outline for the character shape.

2. An apparatus as in claim 1, wherein the first shade and the second shade are contrasting shades.

3. An apparatus as in claim 2, wherein the first layer is disposed on a top surface of the translucent user input element body.

4. An apparatus as in claim 1, wherein the first shade is a light shade and the second shade is a dark shade.

5. An apparatus as in claim 4, wherein the first layer is disposed on a back surface of the translucent user input element body.

6. An apparatus as in claim 5, wherein an edge of the aperture in the first layer is offset in relation to an edge of the aperture in the second layer.

7. An apparatus as in claim 1, wherein the translucent user input element body comprises polycarbonate.

8. An apparatus as in claim 1, wherein the character shape is a number character.

9. An apparatus as in claim 1, wherein the character shape is an alphabet character.

10. An apparatus, comprising:
a user input element, the user input element comprising:
a translucent user input element body;
a first layer comprising a first shade, the first layer disposed on a surface of the translucent user input element body;
a second layer comprising a second shade, the second layer disposed on a surface of the first layer;
an aperture through the first layer and the second layer, the aperture having a character shape; and
the first layer comprising an exposed portion configured to form a dark outline for the character shape;
a backlight arrangement configured to direct light through the user input element.

11. An apparatus as in claim 10, wherein the backlight arrangement comprises a source of white light.

12. An apparatus as in claim 10, wherein the user input element is comprised in an ITU-T keypad.

13. An apparatus as in claim 10, wherein the user input element is comprised in a QWERTY keypad.

14. An apparatus as in claim 10, wherein the apparatus is a mobile electronic device.

15. A method, comprising:
providing a translucent user input element body;
providing a first layer having a first shade, the first layer disposed on a surface the translucent user input element body;
providing a second layer having a second shade, the second layer disposed on a surface of the first layer;
forming an aperture in the first layer and the second layer, the aperture having a character shape;
and configuring the first layer to comprise an exposed portion to form a dark outline for the character shape.

16. A method as in claim 15, wherein the first layer is disposed on a top surface of the translucent user input element body.

17. A method as in claim 16, wherein the aperture is formed by laser engraving.

18. A method as in claim 15, wherein the first layer is formed on a back surface of the translucent user input element body.

19. A method as in claim 18, wherein an edge of the aperture in the second layer comprises an offset in relation of an edge of the aperture in the first layer.

20. A method as in claim 15, wherein at least one of the first layer or the second layer is formed by a printing process.
